(19) United States
(12) Patent Application Publication
(10) Pub. No.: US 2012/0187111 A1
(43) Pub. Date: Jul. 26, 2012

(54) METHOD FOR SOLDERING ELECTRONIC COMPONENTS TO A CIRCUIT BOARD BY MEANS OF HIGH-FREQUENCY SOLDERING

(76) Inventors: Lien-Hsing Chen, Taichung City (TW); Wen-Jen Lai, Taichung (TW)

(21) Appl. No.: 13/050,510

(22) Filed: Mar. 17, 2011

(30) Foreign Application Priority Data
Jan. 21, 2011 (TW) 100102394

(51) Int. Cl. B23K 1/002

(52) U.S. Cl. 219/616

(57) ABSTRACT

A method for soldering electronic components to a circuit board by: applying a solder paste to solder contacts of a circuit board and then arranging electronic components on the circuit board to keep the pins of the electronic components in contact with the solder contacts and then a high frequency to melt the solder paste and to let the pins of the electronic components be electrically connected to the solder contacts of the circuit board electrically by the solder paste.

### BACKGROUND OF THE INVENTION

1. Field of the Invention

The present invention relates to a method for soldering electronic components to a circuit board and more particularly to a method for soldering electronic components to a circuit board by means of employing a high-frequency soldering technique.

2. Description of the Related Art

Conventionally, when soldering electronic components to a circuit board, it is the common way to apply a solder paste, for example, tin paste to solder contacts at the circuit board at first, and then to arrange the electronic components on the circuit board and to keep lead pins of the electronic components in contact with the solder contacts of the circuit board, and then to send the circuit board with the arranged electronic components to a reflow oven. Thus, the high temperature in the reflow oven can melt the solder paste, enabling the electronic components to be soldered to the circuit board.

However, a reflow oven has a big size and occupies much installation space. Further, a reflow oven must be pre-heated to the desired temperature before use. During soldering, the reflow oven transfers thermal energy from its outer side toward its inner side, and therefore the soldering process takes much time to melt the applied solder paste, consuming much electrical energy and increasing the soldering cost.

### SUMMARY OF THE INVENTION

The present invention has been accomplished under the circumstances in view. It is the main object of the present invention to provide method for soldering electronic components to a circuit board, which involves a high-frequency soldering technique.

It is another object of the present invention to provide method for soldering electronic components to a circuit board by employing a high-frequency soldering technique, which prohibits the electronic components from biasing during soldering.

To achieve these and other objects of the present invention, object of the present invention, a method for soldering electronic components to a circuit board includes the steps of: (a) preparing a circuit board having at least one solder contact and a solder paste applied to the at least one solder contact; (b) arranging at least one electronic component on the circuit board and keeping at least one pin of the at least one electronic component in contact with the at least one solder contact of the circuit board; and (c) applying a high frequency to melt the solder paste for enabling the at least one electronic component to be electrically connected to the circuit board electrically by the solder paste. By means of employing a high-frequency soldering technique to melt the applied solder paste rapidly, the invention saves much the soldering time and the consumption of electrical energy and relatively lowers the soldering cost.

Further, the solder paste can be applied to the at least one solder contact by printing.

In one embodiment of the present invention, the solder paste is applied to the top wall of the circuit board over the at least one solder contact during step (a), and the at least one pin of the at least one electronic component is kept in contact with the at least one solder contact at the top wall of the circuit board during step (b).

In another embodiment of the present invention, each solder contact of the circuit board is a via hole and the solder paste is applied to a bottom wall of the circuit board around each via hole during step (a); the at least one pin of the at least one electronic component is respectively inserted into the at least one via hole of the circuit board and kept in contact with the solder paste during step (b).

The method of the invention further comprises, after step (b) and before step (c), a sub step of preparing a cover plate having bottom at least one bottom recess corresponding to the at least one electronic component and then covering the cover plate on the circuit board over the at least one electronic component to accommodate the at least one electronic component in the at least one bottom recess.

Further, applying a high frequency to melt the solder paste during step (c) is done by means of placing the circuit board in an induction coil after arrangement of the at least one electronic component on the circuit board and then applying a high-frequency current to the induction coil to melt the solder paste.

Other and further benefits, advantages and features of the present invention will be understood by reference to the following specification in conjunction with the accompanying drawings, in which like reference characters denote like elements of structure.

### BRIEF DESCRIPTION OF THE DRAWINGS

FIG. 1 is a schematic exploded view illustrating a solder paste applied to a circuit board before bonding of electronic components during the performance of a method for bonding electronic components to a circuit board by means of high-frequency soldering in accordance with a first embodiment of the present invention.

FIG. 2 is a schematic drawing illustrating electronic components arranged on a circuit board before positioning in an induction coil during the performance of a method for bonding electronic components to a circuit board by means of high-frequency soldering in accordance with the first embodiment of the present invention.

FIG. 3 is a schematic drawing illustrating the configuration of a cover plate and arrangement of electronic components on a circuit board before positioning in an induction coil during the performance of a method for bonding electronic components to a circuit board by means of high-frequency soldering in accordance with a second embodiment of the present invention.

### DETAILED DESCRIPTION OF THE INVENTION

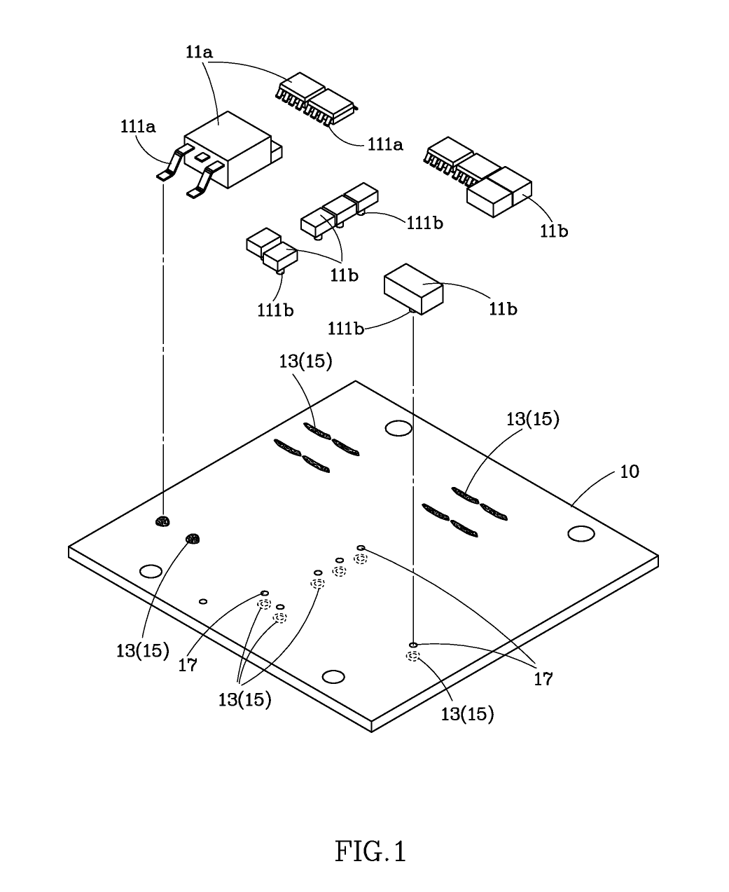

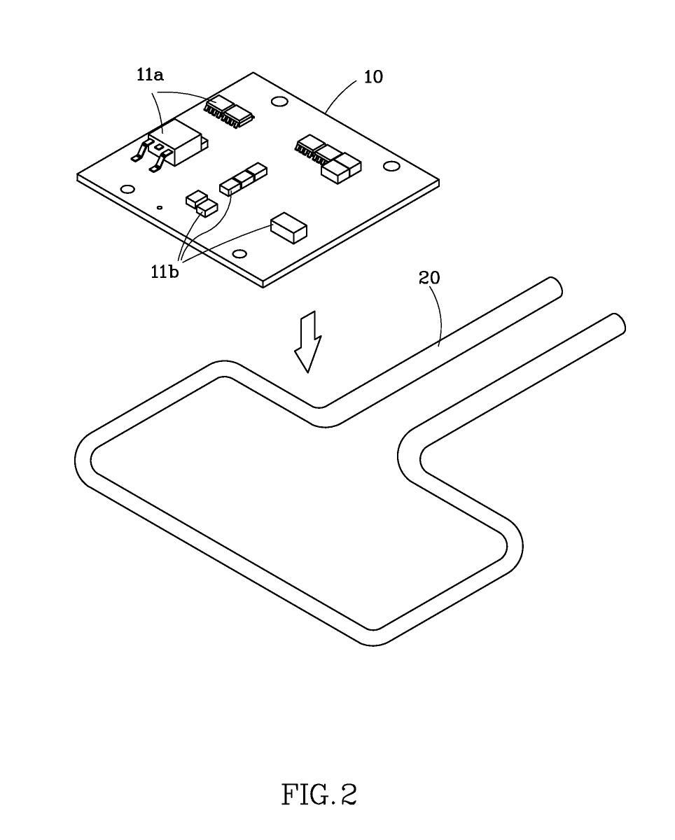

Referring to FIGS. 1 and 2, a method for bonding electronic components to a circuit board by means of high-frequency soldering in accordance with a first embodiment of the present invention includes the following steps:

At first, as shown in FIG. 1, prepare a circuit board 10 having solder contacts 15 and/or via holes 17 and a solder paste 13, for example, tin paste applied to the solder contacts 15 and the bottom wall thereof around each via hole 17. The solder contacts 15 are adapted for bonding electronic components 11a having side pins 111a. The via holes 17 are adapted for bonding electronic components 11b having bottom pins 111b. In actual practice, the solder paste 13 can be directly applied to the solder contacts 15 when performing the soldering technique.

Thereafter, as shown in FIG. 2, attach electronic components 11a and 11b circuit board 10 to keep the side pins 111a of the electronic components 11a in contact with the solder paste 13 at the solder contacts 15 and to insert the bottom pins 111b of the electronic components 11b through the respective via holes 17 into contact with the solder paste 13 at the bottom wall of the circuit board 10.

At final, as shown in FIG. 2, put the circuit board 10 with the attached electronic components 11a and 11b in an induction coil 20 without contact and apply a high-frequency current to the induction coil 20. At this time, the induction coil 20 induces a magnetic field therein to transfer electrical energy to the solder paste 13 by means of an electromagnetic effect. The electrical energy is then converted into heat energy in the solder paste 13, thereby melting the solder paste 13 and electrically bonding the electronic components 11a and 11b to the circuit board 10 within a short period of time. After removal of the circuit board 10 from the induction coil 20, the solder paste 13 is cooled down, and therefore the electronic components 11a and 11b are positively and tightly bonded to the circuit board 10.

In actual practice, the power level of the high-frequency current being applied to the induction coil 20, a length of time in which the high-frequency current is applied to the induction coil 20 and the distance between the induction coil 20 and the circuit board 10 can determine the melting speed of the solder paste 13.

As stated above, the invention involves the application of a high frequency to melt the solder paste rapidly. When compared to the conventional techniques, the invention greatly shortens the soldering time and greatly reduces the consumption of electrical energy, thereby lowering the soldering cost.

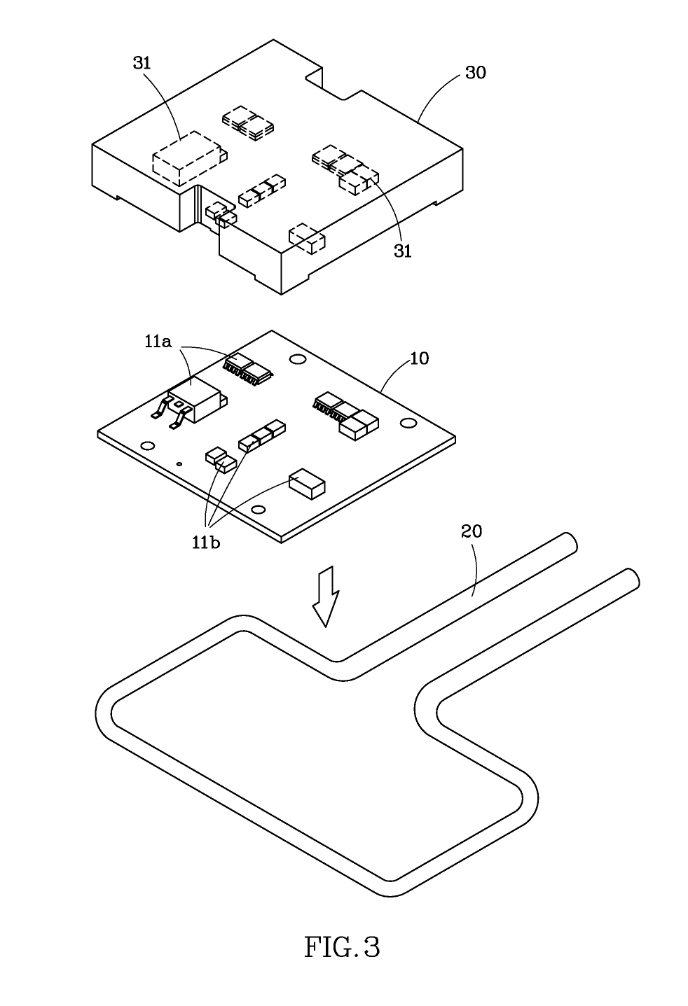

FIG. 3 illustrates a method for bonding electronic components to a circuit board by means of high-frequency soldering in accordance with a second embodiment of the present invention. This second embodiment is substantially similar to the aforesaid first embodiment with the exception of the use of an additional cover plate 30. The cover plate 30 has multiple bottom recesses 31 corresponding to the electronic components 11a and 11b at the circuit board 10. After arrangement of the electronic components 11a and 11b on the circuit board 10 and setting of the circuit board 10 with the electronic components 11a and 11b in the induction coil 20, the cover plate 30 is covered on the circuit board 10 over the induction coil 20 to accommodate the electronic components 11a and 11b in the bottom recesses 31. When applying a high-frequency current to the induction coil 20 to melt the applied solder paste, the electronic components 11a and 11b are constantly kept in position without biasing, assuring a high level of soldering quality.

In conclusion, the invention provides a method for bonding electronic components to a circuit board, which involves a high-frequency soldering technique to melt the applied solder paste rapidly, saving much the soldering time and electrical energy consumption and relatively lowering the soldering cost. Further, subject to the use of the cover plate to hold electronic components in position for accurate soldering, the invention prevents soldering failure due to deviation of electronic components from respective contacts, and assures a high level of soldering quality.

What is claimed is:

1. A method for bonding electronic components to a circuit board, comprising the steps of:
(a) preparing a circuit board having at least one solder contact and a solder paste applied to said at least one solder contact;
(b) arranging at least one electronic component on said circuit board and keeping at least one pin of said at least one electronic component in contact with said at least one solder contact of said circuit board; and
(c) applying a high frequency to melt said solder paste for enabling said at least one electronic component to be electrically connected to said circuit board electrically by said solder paste.

2. The method for bonding electronic components to a circuit board as claimed in claim 1, wherein said solder paste is applied to said at least one solder contact by printing.

3. The method for bonding electronic components to a circuit board as claimed in claim 1, wherein said solder paste is applied to a top wall of said circuit board over said at least one solder contact during step (a); the at least one pin of said at least one electronic component is kept in contact with said at least one solder contact at the top wall of said circuit board during step (b).

4. The method for bonding electronic components to a circuit board as claimed in claim 1, wherein each said solder contact of said circuit board is a via hole and said solder paste is applied to a bottom wall of said circuit board around each said via hole during step (a); the at least one pin of said at least one electronic component is respectively inserted into the at least one via hole of said circuit board and kept in contact with said solder paste during step (b).

5. The method for bonding electronic components to a circuit board as claimed in claim 1, further comprising, after step (b) and before step (c), a sub step of preparing a cover plate having bottom at least one bottom recess corresponding to said at least one electronic component and covering said cover plate on said circuit board over said at least one electronic component to accommodate said at least one electronic component in said at least one bottom recess.

6. The method for bonding electronic components to a circuit board as claimed in claim 1, wherein applying a high frequency to melt said solder paste during step (c) is done by means of placing said circuit board in an induction coil after arrangement of said at least one electronic component on said circuit board and then applying a high-frequency current to said induction coil to melt said solder paste.
